(19) United States
(12) Patent Application Publication
(10) Pub. No.: US 2014/0339139 A1
(43) Pub. Date: Nov. 20, 2014

(54) Autonomously functioning mobile dedusting apparatus with downstream filling station for receptacles

(71) Applicant: PELLETRON CORPORATION, Lancaster, PA (US)

(72) Inventor: Heinz Schneider, Lancaster, PA (US)

(73) Assignee: PELLETRON CORPORATION, Lancaster, PA (US)

(21) Appl. No.: 14/269,851

(22) Filed: May 5, 2014

(30) Foreign Application Priority Data
May 15, 2013 (DE) 10 2013 008 310.9

(51) Int. Cl. B07B 4/00

(52) U.S. Cl. CPC B07B 4/00
USPC 209/133

(57) ABSTRACT

Mobile dedusting and filling unit having a base frame (1) arranged on the chassis (3) and a working platform (2) fixed thereupon, on which an air dedusting device (10) is arranged, the cleaning air thereof is generated by a fan (21) arranged on the base frame (1), which fan is located upstream of a safety filter (37), wherein each mobile dedusting device, capable of completely autonomous function, is displaceable on the silo battery axis and functions together with a weighing and filling device (19) located downstream of the dedusting device and likewise integrated on the moveable frame (2).

The invention relates to an autonomously functioning mobile dedusting device with a downstream filling system for receptacles according to the preamble of claim 1. A mobile dedusting device for filling tankers, which, however, does not function autonomously, is for example known from the subject matter of EP 2 505 272 A1.

From pelletizing up to shipping, plastic granulate or other granular bulk materials are subjected to specific method steps which exert influence on the delivery quality.

Flaking at the pelletizer, cooling temperature limits, pneumatic conveying, mixing, storing, loading, and bagging lead to the formation of abrasion, which can appear in different forms as fines, filaments, scrap, or rubble, The type and size is dependent on the type of plastic and causes large problems (e.g. black fish eyes or white flecks in the end product) during the subsequent processing of the plastic granulate into the end product.

By means of their quality specifications, the processors exert influence on the manufacturers, who install granulate cleaning systems in the production systems, or minimize undesired abrasion by influencing the transport speed, e.g. by slow conveying or super-charged pneumatic conveying (also called STRAND PHASE), or shot peening the inner walls of the pipes. It is not possible to reduce abrasion 100% based on physical circumstances. Slow conveyor systems generate very fine grit due to the high conveyor pressure; in contrast, systems with higher speeds produce coarser grit and filaments.

There are granulate cleaning systems from approximately 50 kg/h to 100 t/h.

In particular, the larger are installed for use with bulk plastics after conveying thereof to the silo facility prior to distribution to the silos. There exists thus still a requirement for transport to the silo battery and to the loading or bagging silo with longer residence times depending on the type of product.

According to experience, however, and since the accumulation of fines described in FEM 2.482 occurs in silos, against which the document warns when taking samples, it is certain that these types of accumulations of fines are also found in tankers, containers, or sacks.

It is therefore necessary to initially carry out granulate cleaning below the loading or bagging silo or at the processing machine.

With regard to bulk plastics, and specifically for high-quality specialty plastics, the abrasion that influences processing quality is generated once again during further conveying downstream of the silo battery to one or more filling stations.

As, according to the prior art, silo batteries are installed for bulk plastics and specialty plastics, which differ according to color and processing specifications; it is therefore uneconomical to equip each silo with a downstream dedusting device and integrated filling device.

Stationary dedusting devices of this type are known from U.S. Pat. No. 5,035,331, U.S. Pat. No. 6,595,369, and U.S. Pat. No. 7,621,975.

EP 2 505 272 A1 discloses a technology in which the dedusting device is combined on a mobile device with a wash air fan having a connection to the silo outlet, a vehicle filling shaft, and dust exhaust lines to a stationary filter system. Thus, it is only known from this document to fill commercial vehicles. A further challenge is to configure the device operation such that adjustments of individual operating parameters based on the numerous different dedusting device locations shall be carried out safely and in a user-friendly way. Filling via a bagging system cannot be gathered from this document. The usable hall height between the silo outlet level and the filling level is designed such that the bagging machines available to the prior art can be moved into this intermediate space. This hall height is approximately 5 to 8 meters, according to the bagging capacity.

A bagging device must be arranged in this region, which bagging device, however, is generally known to have a height of approximately 7 meters. A mobile dedusting device according to EP 2 502 272 A1 has an average height of heights of 3 to 4 meters. According to this, it is not possible according to the prior art to operate a combination of a dedusting device with a bagging system in the hall height between the silo outlet level and the filling level.

With regard to a stationary filter system, it is known that the transport path of the dust to the filter becomes longer, the further away the silo connected to the dedusting device is from the filter, because the dust conveying line has a considerable length. Since the length of the dust conveying line plays a part in the formation of pressure loss, the air flow rate for the fan sinks across the length of the dust conveying line according to the characteristic curve of said fan.

Since the total loss of pressure is composed of throttling and transport distance, then the throttling must be newly reset for optimizing the dedusting device at each silo in order to achieve the optimum operating point of the dedusting device on the characteristic curve of the fans. It is disadvantageous that the fan must be designed for the highest possible pressure, namely according to the distance of the furthest removed silo to the stationary filter system with a corresponding reserve.

A further risk during operation of a dust conveying line is the number of coupling points to be connected to the conveying line in the direction to the filter system, at which no dedusting device is connected.

The mobile dedusting device according to EP 2 505 272 A1 does not function autonomously because it must be connected to a central filter system. With regard to a stationary filter system of this type, however, the transport paths of the dust to the filter are different or always longer, the further the silo connected to the dedusting device is away from the filter system.

It is therefore the underlying object of the invention to further design a method and a device of the type listed at the beginning, such that one or more mobile dedusting devices, without temporal expenditure, can be docked or removed at the selected silo outlet, and that a granulate cleaning is carried out above the filling level during the filling, and a cleaning of the interior spaces in an acceptable period of time is possible during switching to another type of granulate, wherein a weighing and bagging of the cleaned bulk product shall be carried out within the previously described hall height of 5 to 7 meters.

The listed problem is solved by the technical teaching of claim 1.

It is a feature of the invention that each mobile dedusting device capable of complete autonomous function is displaceable on the axis of the silo battery and functions together with a weighing and filling device located downstream of the dedusting device integrated with the moveable chassis.

The inventive dedusting device has a low installation height of only approximately for example 1.10 to 1.20 meters at an output of 40 tons/hour. The low installation height is achieved in that the material flow is separated into two partial flows left and right at the dedusting device inlet and fed back together at the dedusting device outlet. By this means, an unexpectedly low installation height is achieved, and it is thus possible for the first time to operate the mobile dedusting device together with a mobile weighing and bagging system.

The dimensions listed are only to be understood as examples and should not limit the scope of protection of the invention.

Due to this, the advantage exists that this combination of mobile dedusting device and weighing and filling device can be constructed as short and can be operated in the region of the hall between the silo outlet and the filling level.

An additional feature of the invention is accordingly that a mobile, autonomously functioning dedusting device operates in a closed circulation system. In this case, it is important that a filling system is also arranged on the mobile system, which filling system can be executed in a plurality of different versions. It can be implemented as a bagging unit for filling octabins, or for bigbags, or for plastic sacks.

It is essential for all bagging units that the dedusting device, including the wash air unit, is itself arranged on the chassis of the mobile filling system, or—in a second embodiment—the filling or bagging unit is arranged on a separate, mobile chassis and said chassis assigned to the filling system can be connected to the chassis of the mobile dedusting device as one unit.

When separating the two modules, the air dedusting device remains on the chassis of the bagging unit. By this means, the two can be cleaned together, whereas the mobile wash air unit can be connected to another filling system and operated. By this means a module-type assembly of two modules is achieved, which are used in a particularly time saving way.

The first module consists accordingly of a filling unit with the associated air dedusting device, whereas the second module consists of the wash air unit, which consists substantially of the separator (e.g. a cyclone or total separator with a bag filter) itself, the fan, the safety filter, and the associated components.

By this means, the advantage exists, that the filling unit can be subjected to a cleaning procedure with the associated air dedusting device. This type of cleaning is e.g. necessary if a colored granulate was filled and another colored granulate should now be filled in another method process. A cleaning is likewise necessary, when two of the same color granulate are processed, which have, however, different melting indices. In this case, the two modules are separated from each other and the filling unit with the dedusting device unit is subjected to a cleaning procedure. During this cleaning procedure, however, the fresh air unit with the previously listed components, e.g. separator, fan, safety filter, and the like, can be conveyed to another filling unit, connected to the same, and this other filling unit can then be connected to the second module and used during the cleaning time for the first filling unit.

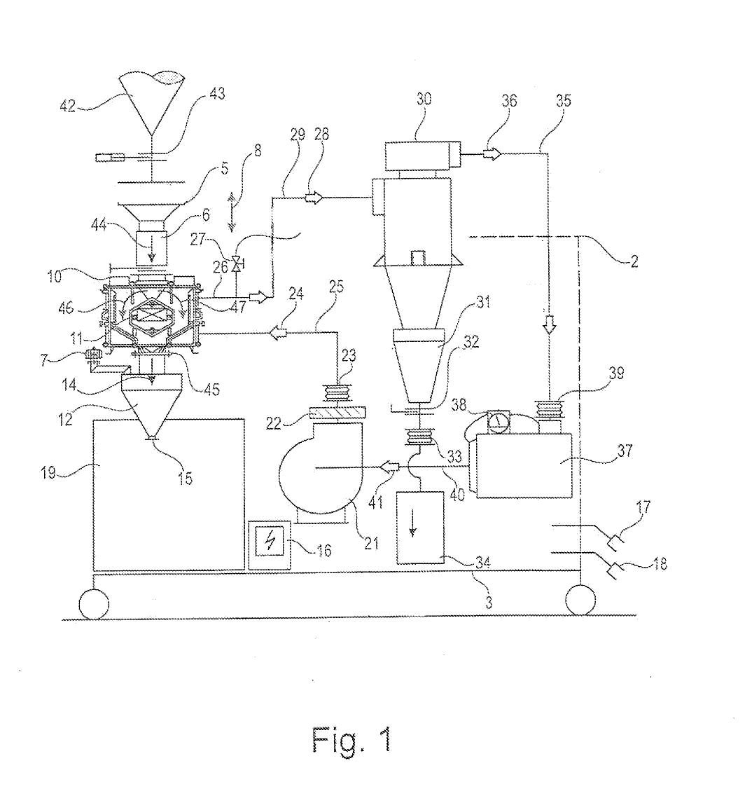

In another variant, which is described in FIG. 1 of the invention, it is provided that the mobile dedusting device including the wash air unit is arranged as an inseparable unit on the chassis of the filling unit. In this arrangement, the advantage results that the mobile dedusting device is already connected from the start to the filling system, and forms with the same a unit. Thus, this is a self-contained system, in which the air is also supplied in a circuit, and the connection of a self-contained system with a filling system has the advantage that no further air connection paths to a central filter station are necessary, because all functional parts are unified on a single, mobile chassis.

Is has previously been known according to the prior art, that there are mobile filling systems; however, without an integrated dedusting device.

An essential feature of the invention is that the inventive system now functions autonomously, which means that the separator (or also the cyclone or also complete separator with integrated filter), in connection with the safety filter (also called an inline filter) and the fan are arranged together on a chassis and form a mobile unit in combination with the remaining features.

This is not found in the prior art. With regard to the prior art according to EP 2 505 272 A1, the separator, the associated safety filter, and the fans were arranged externally. Accordingly, a central filter system was necessary, which was linked to the previously listed disadvantages.

The invention begins here, which describes for the first time a completely autonomously functioning mobile dedusting device with a downstream filling system.

To solve the problem presented, a chassis is accordingly provided, on which chassis the dedusting device, together with fan and separator device or filter is hard-piped forming a single unit, and can be connected to a mobile filling unit.

In this case, the bulk goods are filled, via a supply hopper with pressure equalization necessary for a trouble-free weighing, into a filling unit arranged therebelow for the containers to be weighed such as octabins, bigbags, or sacks, etc.

The docking device for the silo outlet, and connections for electrical current and compressed air are also provided.

As a variant, the autonomously functioning unit can be implemented as a detachable exchangeable module on its own chassis, which module can be connected in turns to a further filling device. The actual dedusting device remains for cleaning on the filling unit and can be separated from the wash air unit. During the cleaning of the filling unit, together with the dedusting device, the wash air unit can be connected to a second filling unit and an associated dedusting device and operated.

The airflow rate is set during start-up and requires no further variation, since there are no different lengths of transport paths, and the dedusting is immediately effective at the beginning of the process without an extensive search for the operating point. A variation of the airflow rate is, however, possible for granulates with different bulk weights, which can occur particularly in the case of specialty plastics.

When determining the fan, a lower pressure can be taken as a basis, which makes itself positively felt during the installation of electrical lines.

A method for operating an autonomously functioning mobile dedusting device with downstream container filling now consists inventively in that the entire system is designed as a closed loop, which implements the granulate cleaning until the predefined weight is achieved in the container. It is suitable for granulates of all types, forms, and colors.

This is thus a closed system, since the wash air provided by the fan downstream of the separator is supplied back to the suction side via a safety filter. The inventive subject matter of the present invention arises not only from the subject matter of the individual claims, but also from the combination of the individual claims with each other.

All details and features disclosed in the documents, including the abstract, in particular the spatial design depicted in the drawings, are claimed as essential to the invention insofar as they are novel individually or in combination over the prior art.

In the following, the invention will be explained in more detail by means of a drawing depicting merely one embodiment. Further features essential to the invention and advantages of the invention arise in this way from the drawing and the description thereof.

The functional parts of an autonomously functioning mobile dedusting device with downstream container filling are schematically depicted in the figures.

As seen in:

FIG. 1: A first embodiment of the autonomously functioning mobile dedusting device with a downstream filling system on a common chassis,

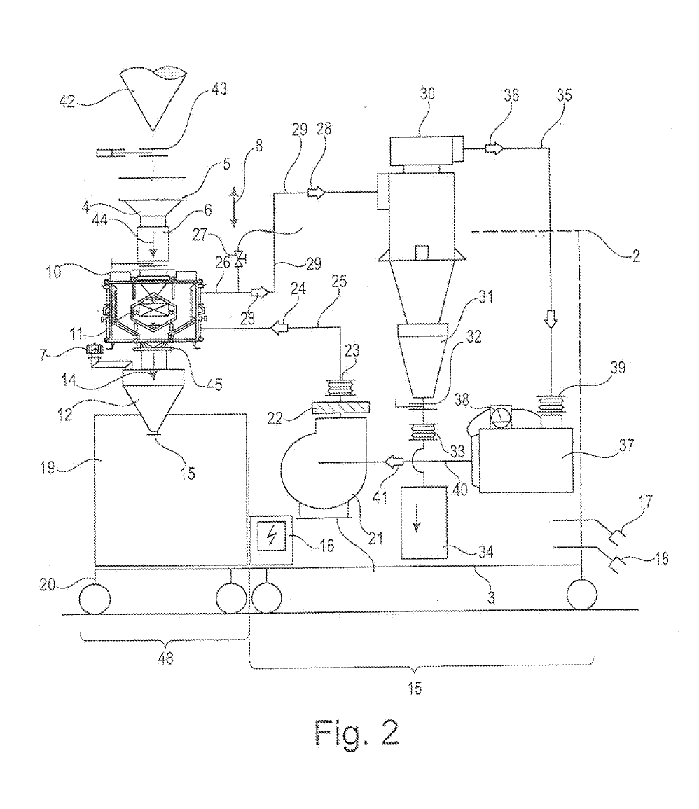

FIG. 2: The same embodiment as in FIG. 1, in which the filling system with parts of the dedusting device is arranged on a separate chassis.

In the following, the invention will be explained in more detail by means of a drawing depicting merely one embodiment. Further features essential to the invention and advantages of the invention arise in this way from the drawing and the description thereof.

The functional parts of an autonomously functioning mobile dedusting device with downstream container filling are schematically depicted in the figures.

A working platform 2 is arranged on a base frame 1. The base frame 1 is supported on a chassis 3, which is freely displaceable on the floor of one level of a factory.

Accordingly, the entire chassis can be moved under any outlet 42 of a storage silo, which is closed by a slider 43. Alternatively, a rotary valve can be used instead.

The material contaminated with dust and foreign matter is drawn out of the outlet 42 when the slider 43 is opened and falls via a docking flange 4 into a material inlet 5, to which a height-adjustable telescopic tube 6 joins.

The telescopic tube 6 is adjustable, corresponding in height to the docking height of the outlet 42 of the storage silo, in that one or more adjustable cylinders 7 are provided which adjustably configure the length of the telescopic tube 6.

A slider 9 (or a rotary valve) is arranged at the outlet of the telescopic tube 6. The material falls in the direction of arrow 44 into the inlet side of an air dedusting device 10 (DeDuster), which contains a fluid bed unit 11 in the interior thereof, said fluid bed is also called a wash deck.

It is important that the flow of goods at the inlet of the air dedusting device 10 is separated into two partial flows 46, 47 lying on the same plane, by which means the installation height of the air dedusting device 10 can be substantially reduced at the same throughput performance as a single-flow dedusting device functioning only vertically. Due to this low installation height, it is possible for the first time to arrange a weighing and bagging system 19 on the chassis (3 or 15 with 45).

The wash air flows through the cover of the fluid bed unit counter the inflowing granulate and removes fines, dusts, and short filaments from the granulate. Longer filaments are primarily removed in the Venturi zone of the air dedusting device.

The cleaned granulate leaves the air dedusting device 10 via the outlet 45 and falls in the direction of arrow 14 downward into a filling pipe 12. The filling pipe 12 or a hopper is placed exactly on or on top of an intake 15 of a weighing and filling device 19.

On the chassis 3 of the mobile unit, there are also an electrical connection 17 for supplying the electrical elements and additionally a compressed air connection 18.

The individual electrical functions of the various electrical devices are set using a control cabinet 16.

The wash air for the air dedusting device 10 is provided by a fan 21, which blows the wash air in the direction of arrow 24 into the inlet 25 at the air dedusting device 10 via a control damper 22 and a flexible connection 23.

The control damper 22 is set in such a way that the airflow rate at the outlet is determined according to the optimum characteristic curve of the fan.

Alternatively, the rotational speed of the fan 21 can be controlled by a frequency converter and different air volumes and pressures can be set in that way.

The contaminated air loaded with dust and filaments is blown out of the air dedusting device 10 via the outlet 26 and leaves the air dedusting device in the direction of arrow 28. In this segment, a control valve 27 is present. Additional fresh air can be supplied into the line at the outlet 26 via the control valve 27.

The contaminated air arrives via the dusty air line 29 at the inlet side of a separator 30, which is preferably designed as a high-efficiency cyclone separator.

A separation of the solid parts (fines and dust) from the airflow of the dusty air line 29 takes place in the separator 30, so that these solid parts are supplied into a squirrel cage 34 via the outlet cone 31 and an elastic connection 33. The underside of the outlet cone 31 is closed by a slider 32 or by a rotary valve (not shown) as needed.

The air cleaned by the separator 30 leaves the separator at the head thereof as clean air line 35 in the direction of arrow 36 and is guided to the suction side of a safety filter 37 via a flexible connection 39.

The safety filter 37 serves to prevent that any potential dust or filaments not yet separated out from arriving in the fan 21.

This is thus a near-mesh size determination, which means that the safety filter 37 contains only specific, not separated parts. The filter effect thereof is checked by a pressure gauge 38.

The air thus cleaned leaves the suction line 40 at the outlet of the safety filter 37 for the fan 21, which draws in the cleaned air in the direction of arrow 41 and blows it into the closed system again.

The advantage of the entire system is that it functions autarkically, that means without needing the assistance of external components. The carriage with the chassis 3 requires merely an electrical connection 17 and a compressed air connection 18. Otherwise, the entire system functions without the assistance of further components.

It is important that the device can be autonomously operated, which means that the airflow is supplied in a closed circuit, by which means air losses are avoided and the air dedusting device 10 can immediately begin with the cleaning of the granulate upon the entry of the contaminated granulate at the inlet (at the direction of arrow 44), without needing adjustment work, as is pre-specified for EP 2 505 272 A1.

Thus, no extensive adjustment work is required at the control damper 22 in order to maintain the fan 21 in the optimum operating point thereof, because the air supplied in the circuit is always supplied into the air dedusting device 10 at the same airflow rate and the same pressure via the control damper 22, which is adjusted once, which was not the case for EP 2 505 272 A1. The same advantages are achieved using a frequency converter for control.

### LIST OF REFERENCES

1 Base frame
2 Working platform
3 Chassis
4 Docking flange
5 Material inlet
6 Telescopic tube
7 Adjustment cylinder
8 Direction arrow
9 Slider
10 Air dedusting device
11 Fluid bed unit
12 Filling tube
13 Lifting device
14 Direction arrow
15 Feed (tanker)
16 Control cabinet
17 Electrical connection
18 Compressed air connection
19 Weighing and filling device
20 Drive motor
21 Fan
22 Control damper
23 Flexible connection
24 Direction arrow
25 Inlet (of 10)
26 Outlet (of 10)
27 Control valve
28 Direction arrow
29 Dusty air line
30 Separator
31 Outlet cone
32 Slider
33 Elastic connection
34 Squirrel cage
35 Clean air line
36 Direction arrow
37 Safety filter
38 Pressure gauge
39 Flexible connection
40 Sanction line
41 Direction arrow
42 Outlet (storage silo)
43 Slider
44 Direction arrow
45 Outlet
46 Partial flow
47 Partial flow

1-10. (canceled)

11. A mobile classifier comprising:
a mobile frame;
a dedusting apparatus mounted on said frame and positionable in communication with a supply of contaminated particulate material, said dedusting apparatus being operable to remove contaminates from said particulate material to create cleaned particulate material;
a filling station mounted on said mobile frame for support of a receptacle to receive said cleaned particulate material from said dedusting apparatus; and
a closed circuit air supply apparatus coupled to said dedusting apparatus to provide a flow of air thereto, said closed circuit air supply apparatus being operable to collect a discharge of air entrained with contaminates from said dedusting apparatus, to remove the contaminates from said discharge of air, and to provide a cleaned supply of air to said dedusting apparatus.

12. The mobile classifier of claim 11 wherein said filling station includes a weighing and filling device located downstream of said dedusting apparatus, said weighing and filling device being supported on said mobile frame.

13. The mobile classifier of claim 12 wherein said mobile classifier comprises first and second independently displaceable modules coupled to one another.

14. The mobile classifier of claim 13 wherein said weighing and filling device and said dedusting apparatus are included in said first module, said second module including said closed circuit air supply apparatus.

15. The mobile classifier of claim 14 wherein said closed circuit air supply apparatus includes an air wash unit and a separator to remove the contaminates from said discharge of air, and a fan and a safety filter to provide a cleaned supply of air to said dedusting apparatus.

16. The mobile classifier of claim 15 wherein the cleaned particulate material is discharged through an outlet into a filling tube directed the cleaned particulate material to said weighing and filling device.

17. The mobile classifier of claim 15 wherein said fan directs a flow of cleaned air into an air inlet of said dedusting apparatus, a control of the rate of flow of cleaned air into said dedusting apparatus can be provided via a control damper or via manipulation of the rotational speed of said fan.

18. A mobile dedusting and filling apparatus comprising:
a mobile chassis defining a working platform;
a dedusting device supported on said chassis for selective positioning in alignment with a silo containing a supply of particulate material for feeding into said dedusting device for the removal of contaminates therefrom;
a fan supported on said chassis to provide a flow of cleaning air into an air inlet on said dedusting device to remove said contaminates from said particulate material to create cleaned particulate material; and
a weighing and filling device supported on said mobile chassis to receive said cleaned particulate material from said dedusting device.

19. The mobile dedusting and filling apparatus of claim 18 wherein said mobile dedusting and filling apparatus comprises first and second independently displaceable modules coupled to one another.

20. The mobile dedusting and filling apparatus of claim 19 wherein said weighing and filling device and said dedusting device are included in said first module, said second module including a closed circuit air supply apparatus that includes said fan.

21. The mobile dedusting and filling apparatus of claim 19 wherein said closed circuit air supply apparatus includes an air wash unit and a separator to remove the contaminates from said discharge of air, and a safety filter cooperable with said fan to provide a cleaned supply of air to said dedusting device.

22. The mobile dedusting and filling apparatus of claim 21 wherein the cleaned particulate material is discharged through an outlet into a filling tube directed the cleaned particulate material to said weighing and filling device.

23. The mobile dedusting and filling apparatus of claim 21 wherein said fan directs a flow of cleaned air into an air inlet of said dedusting device, a control of the rate of flow of cleaned air into said dedusting device can be provided via a control damper or via manipulation of the rotational speed of said fan.

24. A method of operating a mobile dedusting apparatus comprising the steps of:
mounting a dedusting device on a mobile frame;
aligning said dedusting device with a silo containing a supply of particulate material and contaminates;
generating a supply of air from a closed loop air supply apparatus mounted on said mobile frame and including a fan operable to direct said supply of air into said dedusting device to clean said contaminates from said particulate material to create cleaned particulate material; and
discharging said cleaned particulate material into a weighing and filling apparatus for removal from said mobile dedusting apparatus.

25. The method of claim 24 further comprising the steps of:
discharging said contaminates entrained in a flow of air from said dedusting device;
removing said contaminates from said flow of air from said dedusting device; and
passing said air through a filter before being directed to said fan.

26. The method of claim 25 wherein said supply of air is provided to said dedusting device at a flow rate controlled by a control damper associated with said fan, said control damper being adjusted by setting an optimum characteristic curve for said fan.

27. The method of claim 25 wherein said supply of air is provided to said dedusting device at a flow rate controlled by manipulating a rotational speed of said fan.

28. The method of claim 25 wherein said mounting step establishes first and second modules of said dedusting apparatus with said dedusting device being mounted on said first module with said weighing and filling apparatus while said closed loop air supply apparatus is mounted on said second module.
